(19) United States
(12) Patent Application Publication
(10) Pub. No.: US 2009/0031152 A1
(43) Pub. Date: Jan. 29, 2009

(54) METHOD FOR STARTING UP AT LEAST ONE FIELD DEVICE

(76) Inventors: Wolfgang Bolderl-Ermel, Wendelstein (DE); Michael Kasper, Nurnberg (DE); Jurgen Schimmer, Nurnberg (DE); Richard Schmidt, Baiersdorf (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/224,484

(22) PCT Filed: Jul. 27, 2007
(86) PCT No.: PCT/EP2007/057795

§ 371 Date: Aug. 26, 2008

(30) Foreign Application Priority Data
Aug. 7, 2006 (DE) 10 2006 036 770.7

(51) Int. Cl. G06F 1/26

(52) U.S. Cl. 713/300

(57) ABSTRACT

Disclosed is a method for starting up of at least one first field instrument, wherein the method comprises the step of signaling a firs demand for electrical power output of the first field instrument over a first port to a supply unit. According to this method, the first field instrument is previously connected to the supply unit over the first port by means of a first communication connection. In addition, the reception of the power output is effected according to the first demand for power output by the first field instrument over the first communication connection and the first port, by which the first filed instrument is activated. In an additional step, a power usage unit of the first field instrument is assigned to the first port, wherein the power usage unit is provided as consumer load for the power output.

### CROSS REFERENCE TO RELATED APPLICATIONS

This application is the US National Stage of International Application No. PCT/EP2007/057795, filed Jul. 27, 2007 and claims the benefit thereof. The International Application claims the benefits of German application No. 10 2006 036 770.7 filed Aug. 7, 2006, both of the applications are incorporated by reference herein in their entirety.

### FIELD OF INVENTION

The invention relates to a method for starting up and operating at least one field device in general and a method for starting up a field device, whose energy requirement is supplied by way of an Ethernet connection (power over Ethernet) in particular. In a different aspect the invention relates to a field device and a supply unit, such as a power feeder or a power over Ethernet (PoE) switch. The invention also relates to a computer program product for executing the inventive method.

### BACKGROUND OF THE INVENTION

Power over Ethernet (PoE) describes a technology, which can be used to supply network-capable devices with power by way of the 8-core Ethernet cable. In a narrower sense PoE now generally refers to the IEEE standard 802.3af, the final version of which was adopted in July 2003. Before that there were some manufacturer-specific implementations, which also went under the name of power over Ethernet.

The main advantage of power over Ethernet is that a power supply cable can be dispensed with and it is therefore possible to install devices with an Ethernet connection even in places which are not easy to access and in areas where a large number of cables would be problematic. It is thus possible on the one hand to reduce installation costs and on the other hand the easy deployment of a central, uninterrupted power supply can enhance the fail-safe nature of the connected devices.

Power over Ethernet is generally utilized by consumer devices which consume little power. Examples of these are IP telephones, small hubs, small cameras, small servers or cordless transmission devices (WLAN, ACCESS points, FSO devices, BlueTooth ACCESS points).

Power over Ethernet is also used in automation engineering, for example for field devices in manufacturing or logistics applications. Here the individual field devices, of which a manufacturing or logistics application consists, are networked by way of the Ethernet technology.

According to the IEEE standard 802.3af the devices in question are divided into energy suppliers (Power Sourcing Equipment, PSE) and consumers (Powered Devices, PD). The energy suppliers are also referred to below as supply units or power supply units. The consumers are also referred to below as power drawing units. The supply voltage supplied to a consumer during operation is 48 volts. The maximum current take-up of the field devices is 350 mA in continuous operation. In the short term 400 mA is permitted on connection. This gives a maximum power take-up of 15.4 watts. Both free core pairs and signal-carrying cores are used to transmit power in the Ethernet cable.

The challenge for manufacturers of proprietary PoE solutions in the past was to avoid damage to non-PoE-capable terminals.

The standard 802.3af resolves this problem by means of a method known as resistive power discovery. Here the energy supplier, in other words the supply unit, first repeatedly supplies just a minimal current to the cores of the Ethernet connection, by way of which a consumer is connected to the supply unit, no device normally being damaged by the minimal current. The energy supplier thereby identifies whether and where the consumer has a 25 kOhm terminal resistance and is therefore power over Ethernet capable. The consumer is then supplied with a low level of power and must then signal which of four power classes defined in the standard it belongs to. Only then is the consumer supplied with the full power and is able to start operation.

Power can be supplied to the field devices and/or consumers by means of so-called endspan devices (for example switches) or midspan devices (units between switch and field device). The midspan devices uses are generally hubs, which supply power to the respective wires. For midspan supply a so-called power feeder or midspan insertion panel is positioned between the Ethernet switch and the field devices, in other words the PD devices. These systems resemble patch panels and typically have between 6 and 24 channels. Each power feeder has an input for incoming data and a combined output for data and power supply via PoE.

The overall power supply provided by such an Ethernet switch or power feeder is limited because of power losses. Each terminal can request a certain power budget at its terminal, in other words at the port by way of which the field device is connected to the supply unit. This power budget is classified in a number of stages by the field device by way of a defined power impedance, as mentioned above.

Ethernet technologies with a line structure are deployed in many industrial applications. Such line structures are advantageous for example in the case of manufacturing or logistics applications. The field devices, which communicate with one another in a line structure, must each have at least two communication ports. One of these ports serves for example to connect it to the higher-order system or a switch. A second port serves to forward data to the adjacent field device.

In the case of line or ring topologies with such structures the power supply cannot be used for a number of PoE field devices arranged in a line for example in accordance with the standardized power over Ethernet method according to the IEEE standard 802.3af. One reason for this is that the supplying PSE switch or power feeder cannot supply a number of consumers connected one behind the other with power, since only the consumer connected directly to the power over Ethernet switch or power feeder can signal its own power requirement. The first of the consumers arranged in a line could therefore always request the maximum power budget. This would however on the one hand not comply with IEEE 802.3af, as its actual power take-up is generally considerably lower. On the other hand downstream consumers can cause this maximum power budget to be exceeded, which will result in the disconnection of the entire line by the supply unit.

### SUMMARY OF INVENTION

The object of the invention is therefore to specify an improved method for starting up at least one field device, so that according to the method a number of field devices connected one behind the other, for example in a line structure or ring structure, can also be started up. The object of the invention is also to specify an improved field device and an improved supply unit. The object of the invention is also to specify a computer program product for implementing the inventive method.

The objects underlying the invention are respectively achieved by the features of the independent claims. Embodiments of the invention are set out in the dependent claims.

The invention specifies an improved method for starting up at least one first field device, the method including the step of signaling a first electrical power requirement of the first field device to a supply unit by way of a first port, the field device having been connected previously to the supply unit by way of the first port by means of a first communication connection. The method also includes the step of the first field device taking up the electrical power according to the first electrical power requirement by way of the first communication connection and the first port, as a result of which the first field device is activated. The method also includes the step of allocating a power drawing unit of the first field device to the first port, the power drawing unit being provided as a consumer for the power. The method also includes the step of allocating a power supply unit of the first field device to a second port, the power supply unit being provided to supply a second power requirement by way of the second port.

After connection of the first port, the first field device signals its first power requirement to the supply unit by way of the first communication connection. Signaling here means for example that an impedance of defined size (25 kOhm) is present for example as a device-specific signature on the side of the field device, so that the field device can be identified as a PD device by the supply unit, as set out in the IEEE standard 802.3af, and as a result the supply unit can determine the first electrical power requirement of the first field device. The supply unit can activate the field device by supplying the power corresponding to the first power requirement, which is taken up by the field device. The field device has a power drawing unit, which is then allocated to the first port. The power drawing unit is provided as a consumer for the power supplied. The field device therefore has PD characteristics at the first port. The power supply unit of the field device is also allocated to the second port. The first field device therefore has PSE characteristics at the second port.

According to one embodiment of the invention the method also includes the step of detecting a second field device by way of the second port of the first field device, the second field device having been connected previously to the second port of the first field device by way of a second communication connection. The second electrical power requirement of the second field device is also determined by way of the second communication connection. In a further step the overall electrical power requirement is determined from the first and second electrical power requirements. The overall electrical power requirement is also transmitted to the supply unit. In a further inventive method step all the power according to the overall power requirement is taken up by the first field device, with all the power being supplied by the supply unit, if the supply unit can supply all the power. The second field device is also supplied with power according to the second electrical power requirement, if all the power is received by the first field device.

Therefore after the first field device has been started up by the supply unit, the second field device is connected by way of the first field device and by way of the first and second communication connections to the supply unit and started up by the first field device according to the invention. The invention is particularly advantageous, since a number of consumers connected one behind the other can be supplied with power by an upstream supply device. As mentioned above, there is no provision for this in the IEEE standard 802.3af.

According to a further embodiment of the invention the method also includes the step of monitoring the second port supplied by the first field device. The inventive method also includes the step of interrupting the supply to the second field device in the event of a short circuit or excess current in the second communication connection. Automatic organization of the PoE line results in that each field device, in this instance the first field device, for example continuously monitors the outgoing port supplied by it, in this instance the second port for example during ongoing operation. In the event of excess current or a short circuit in the outgoing connection the supplying device interrupts the power supply to the adjacent device, in this instance the second field device. This means that there is selectivity in the event of a fault; in other words only the devices affected by the short circuit are isolated from the power supply rather than the entire line.

According to one embodiment of the invention the inventive method also includes the step of storing some of the electrical energy received and the step of monitoring the supplying first port. This makes it possible to detect an interruption of the energy supply to the first field device. There also follows the step of changing the assignment of the power drawing unit and the power supply unit to the first and second ports, if an interruption of the energy supply is detected.

By monitoring the supplying port it is possible to identify an interruption of the energy supply promptly. The field device, in this instance the first field device for example, can then change the PSE/PD assignment to its ports. If the field device is incorporated in a ring topology for example, by appropriate buffering or energy storage of some of the electrical energy already received by the field device it is possible for the device to remain active despite the power interruption and for the energy flow direction to be reversed so that it is supplied for example by the second port.

According to one embodiment of the invention a change in the second power requirement of the second field device is detected by the first field device, the changed overall power requirement being transmitted to the supply unit and the power being supplied to the second field device according to the changed second power requirement, if the power according to the changed overall power requirement is taken up by the first field device. The first field device can thus detect a change in the second power requirement of the second field device at any time during ongoing operation and correspondingly request a changed overall power requirement from the supply unit. This is advantageous for example, if a third device is connected to the second device, which is now started up by the second field device, as the second device was started up by the first field device. The second field device then reports its own power requirement and that of the third field device to the first field device as the changed second power requirement, said first field device transmitting the changed overall power requirement correspondingly to the supply unit. If the first device can take up the changed overall power requirement, it supplies the correspondingly requested power to the second field device. The second field device can then activate the third field device, as described above for the first and second field devices. The inventive method has the advantage that line structures and also ring structures can now be realized by means of the inventive embodiment of the field devices. The field devices adjacent to the feeding switch or power feeder are activated one after the other. During start up this process does not result in any noticeable communication delay. Nor does the inventive method require any particular configuration of the individual field devices. It is also advantageous that the power budget available for the line structure or for the ring structure and the power requirement of the connected devices are equalized with each further activated device, since the device preceding the further device must always request the required power from the preceding device. Overloading of the overall line structure is therefore excluded.

According to one embodiment of the invention the overall power requirement or the changed overall power requirement is transmitted from the field device to the supply unit by means of the SNMP protocol (Simple Network Management Protocol).

According to one embodiment of the invention the second field device is detected by the first field device by means of the LLDP protocol (Link Layer Discovery Protocol).

According to one embodiment of the invention the field devices have a device-specific signature at the first and second ports in the powerless state, the device-specific signature showing the field devices to be power drawing units, with the device-specific signature being deactivated after activation of the field device. As mentioned above, according to the invention in the powerless state the devices have a signature at their ports, by means of which they can be identified as PD devices according to the IEEE 802.3af standard. Since the second port in particular, which is used as a PSE port when the field device is activated, can no longer have PD functionality when the device is activated, the device-specific signature is deactivated after activation of the device.

According to one embodiment of the invention the second power requirement of the second field device is determined by way of the device-specific signature of the second field device.

According to one embodiment of the invention the actual power take-up of the connected devices can be transmitted after activation of the devices by way of the SNMP protocol. By summing the individual exact power values, this power data results in an overall lower summed power, which has to be supplied as the power budget by the supply unit. In contrast summing the only three possible power stages of 4W, 7W and 15.4W, which are defined for the conventional PoE, always results in an unnecessarily high power budget.

According to one embodiment of the invention the device-specific signature is realized by means of a power terminal impedance according to the IEEE 802.3af standard.

According to a further embodiment of the invention the first communication connection and the second communication connection are based on Ethernet technology.

According to one embodiment of the invention the supply unit is a field device upstream of the first field device or a power over Ethernet switch or a power feeder.

In a different aspect the invention relates to a field device with at least one first and one second port, with at least one power supply unit, it being possible for the power supply unit to be allocated to the at least first and/or second port and the power supply unit being provided to supply electrical power by way of the allocated port. The field device also has at least one power drawing unit, it being possible for the power drawing unit to be allocated to the at least first and/or second port, the power drawing unit being provided as a consumer for the electrical power received by way of the allocated port.

In a different aspect the invention relates to a supply unit for supplying at least one field device with electrical power by way of a communication connection with means for receiving a first message from the field device by way of the communication connection, the first message containing information about the power requirement of the field device and with means for detecting whether the power requirement can be supplied by the supply unit. The supply unit also has means for transmitting a second message to the field device by way of the communication connection, the second message containing information about whether the power requirement can be supplied. The supply unit also has means for supplying the power requirement for the field device by way of the communication connection.

In a different aspect the invention relates to a computer program product with computer-executable instructions, it being possible for the step of receiving a first message from the field device by way of the communication connection to be executed by means of the instructions, the first message containing information about the power requirement of the field device. Detection also takes place to determine whether the power requirement can be supplied by the supply unit and a second message is transmitted by way of the communication connection to the field device, the second message containing information about whether the power requirement can be supplied. The power requirement for the field device is also supplied by way of the communication connection. The first message and/or second message is/are hereby transmitted for example by means of the above-mentioned SNMP protocol, if the communication connection is an Ethernet connection.

In a different aspect the invention also relates to a computer program product with computer-executable instructions for the starting up of at least one second field device by a first field device, the computer program product containing computer-executable instructions, the step of detecting the second field device by way of a second port of the first field device being executed by means of the instructions, the second field device having been connected previously to the second port of the first field device by way of a second communication connection. The step of determining a second power requirement of the second field device is also executed by way of the second communication connection. The overall power requirement is also determined by means of a first power requirement and the second power requirement, the first power requirement corresponding to the power requirement of the first field device. A first message is also transmitted to a supply unit, the supply unit having been connected previously by way of a first port and a first communication connection to the first field device, the first message containing information about the overall power requirement.

### BRIEF DESCRIPTION OF THE DRAWINGS

Embodiments of the invention are described in more detail below with reference to the drawings, in which

FIG. 1 shows a block diagram of a line structure with a supply unit and a first and second field device,

FIG. 2 shows essential steps of the inventive method in a flow diagram,

FIG. 3 shows a sequence diagram showing the sequences between the supply unit and the first and second field devices when starting up the field devices,

FIG. 4 shows a schematic diagram of the structure of a network, having line structures and a ring structure,

FIG. 5 shows a block diagram of a field device,

FIG. 6 shows a schematic illustration of the potential isolation between the two ports of the field device in a block diagram of a field device,

FIG. 7 shows a block diagram of a field device with T-piece functionality.

### DETAILED DESCRIPTION OF INVENTION

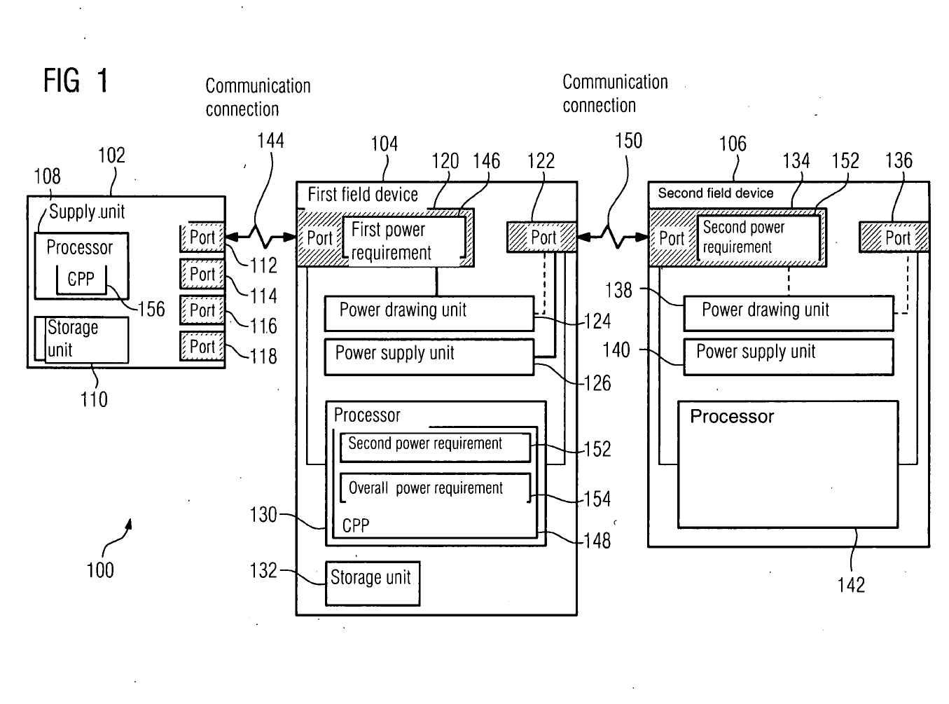

FIG. 1 shows a block diagram of a line structure 100. The line structure 100 here has a supply unit 102, a first field device 104 and a second field device 106. The supply unit 102 here is a device that has PSE functionality according to the IEEE standard 802.3af. The supply unit 102 is supplied externally with electrical energy. The supply unit 102 also has a processor 108, a storage unit 110 and ports 112, 114, 116 and 118.

The first field device 104 has a first port 120 and a second port 122. The first field device 104 also has a power drawing unit 124 and a power supply unit 126. The first field device 104 also has a processor 130 and a storage unit 132.

Like the first field device 104 the second field device 106 has a first port 134, a second port 136, a power drawing unit 138, a power supply unit 140 and a processor 142.

The power drawing units 124 and 138 here have the functionality of a PD device according to the IEEE standard 802.3af. The power supply units 126 and 140 have the functionality of a PSE device according to the above standard. The first field device 104 and second field device 106 therefore have both PD and PSE functionality.

The first field device 104 signals PD characteristics according to IEEE standard 802.3af to its ports 120 and 122 in the powerless state. To this end in the powerless state the power drawing unit 122 is connected to the first port (characterized by the solid line between the power drawing unit 124 and the first port 120) and to the second port 122 (broken line between the power drawing unit 124 and the second port 122). The field device 104 therefore signals its PD characteristics to the supply unit 102, when it is connected to the supply unit 102 by way of a first communication connection 144, e.g. by way of the port 120 and the port 112.

The supply unit 102 can thus determine the first electrical power requirement 146 of the first field device 104 according to the above-mentioned standard and supply the power to the first field device 104 according to the first power requirement 146. The first field device 104 is activated by the power take-up.

The power drawing unit 124 is now allocated to the first port 120. The PD signaling at the second port 122 is blocked. The power supply unit 126 is allocated to the second port 122. The second port 122 therefore has PSE characteristics.

Activating the first field device 104 also causes the processor 130 to become active. The processor 130 executes a computer program product 148, which is loaded from the storage unit 132, in which the computer program product 148 is permanently stored, when the processor 130 is started up.

In the powerless state the second field device 106 signals its characteristic as a PD device to its ports 134, 136, as the first field device 104 did before. If the second field device 106 is now connected by way of its first port 134 and by way of a second communication connection 150 to the second port 122, the first field device 104 can detect the second field device 106. The computer program product 148 uses the LLDP protocol (Link Layer Discovery Protocol) for example for this purpose.

The power supply unit 126 can then determine the second electrical power requirement 152 of the second field device 106 according to the IEEE 802.3af standard. The computer program product 148 then determines an overall electrical power requirement 154 from the first power requirement 146 and the second power requirement 152, with the overall power requirement 154 corresponding to the sum of the first power requirement 146 and the second power requirement 152.

The computer program product 148 now sends a first message by way of the communication connection 144 for example by means of SNMP (Simple Network Management Protocol) to the supply unit 102, the overall power requirement 154 being transmitted to the supply unit 102 with the message.

The processor 108 executes a computer program product 156, which is permanently stored in the storage unit 110 and is loaded onto the processor 108 when the supply unit 102 is started up. The computer program product 156 is used to read the overall power requirement 154 out from the received message and to check whether the supply unit 102 can supply the overall electrical power requirement 154. If so, the computer program product 156 sends a second message to the first field device 104, confirming the building up of the power made available.

As soon as the overall power requirement 154 is taken up by the first field device 104, the first field device 104 makes the power corresponding to the second power requirement 152 available to the second field device 106. The second field device 106 is then activated. The power drawing unit 138 is then allocated to the first port 134, so that the second field device 106 has PD functionality at this port. The power supply unit 140 is then also allocated to the second port 136, so that the second port 136 has PSE functionality.

A further field device (not shown in FIG. 1) can be connected to the second port 136. The further field device is then started up by the second field device 106 in the same manner as this second field device 106 was started up previously by the first field device 104. In this process the second field device 106 uses the processor 142 and the corresponding computer program product (like computer program product 148) to determine the overall power requirement of the second field device and the further field device. The second power requirement 152, which is now transmitted to the first field device, hereby corresponds to the overall power requirement of the second field device 106 and the further field device.

All the field devices, in other words the field device 104 as well, monitor the supplied ports continuously. The first field device 104 is thus able to detect the new overall second power requirement. This changed second power requirement now impacts on the overall power requirement 154, which likewise changes. The changed overall power requirement is now reported to the supply unit 102, as the overall power requirement 154 was previously. If the supply unit 102 can supply the changed overall power requirement, the first field device 104 can take up this overall power requirement and thus make the power according to the changed second power requirement available to the second field device 106. The second field device 106 can then activate the further device by supplying the corresponding power. It is thus possible to set up a line structure, which is supplied by an upstream supply unit 102.

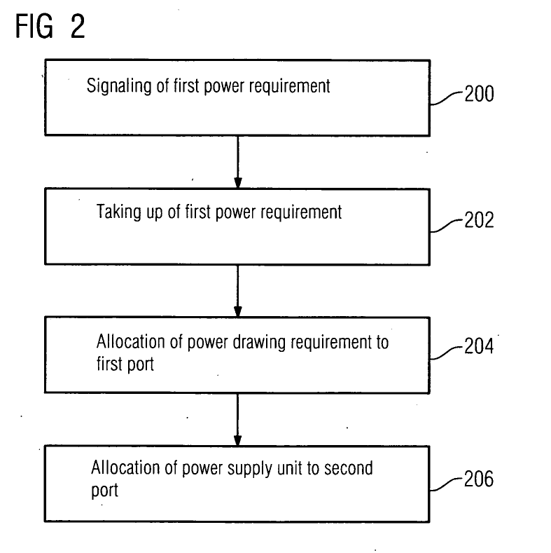

FIG. 2 shows a flow diagram illustrating the method steps of a method for starting up at least one first field device. In step 200 a first electrical power requirement of the first field device is signaled by way of a first port to a supply unit, the field device having been connected previously to the supply unit by way of the first port by means of a first communication connection. In step 202 the power according to the first electrical power requirement is taken up by the first field device by way of the first communication connection and the first port, with the result that the first field device is activated. In step 204 a power drawing unit of the first field device is allocated to the first port, the power drawing unit being provided as a consumer for the power. In step 206 a power supply unit of the first field device is also allocated to a second port, the power supply unit being provided to supply a second power requirement.

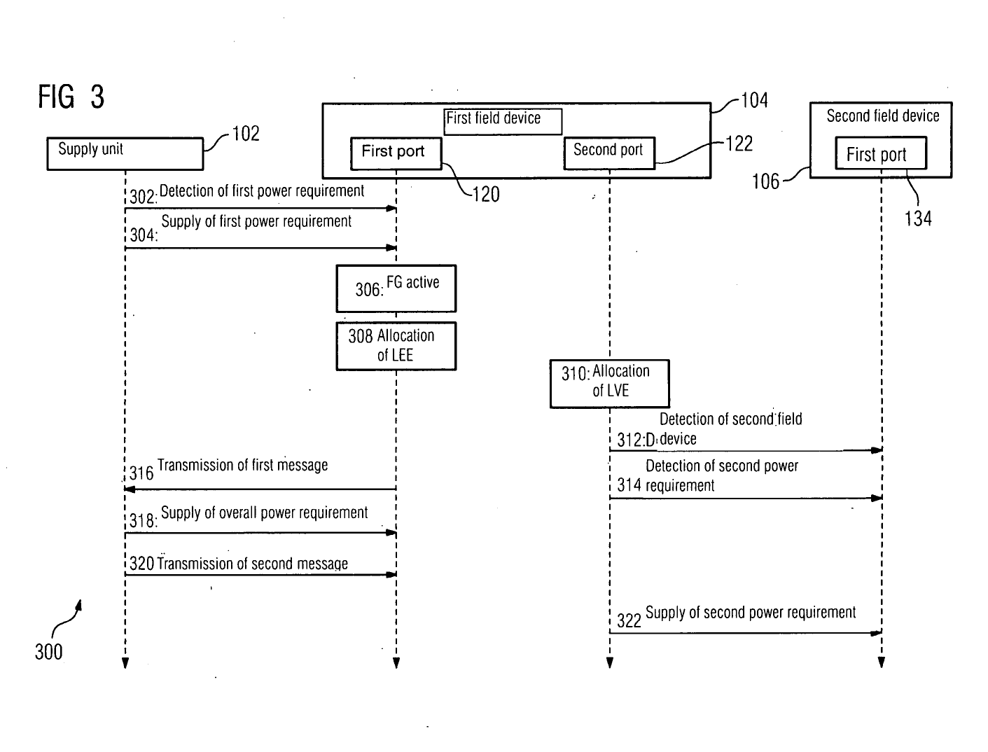

FIG. 3 shows a sequence diagram 300, which shows the sequences between the supply unit 102, the first field device 104 and the second field device 106 when the field devices 104 and 106 are started up. The corresponding reference characters from FIG. 1 have been used here to identify the supply unit and the field devices and their ports. The first field device 104 has the first port 120 and the second port 122. The second field device has the first port 134 (the second port is not shown here for reasons of expediency).

The broken lines below the supply unit 102, the first port 120, the second port 122 and the first port 134 here relate to the time order of the sequences in the corresponding units. The sequences between the corresponding units are identified by the horizontal solid arrows. Above each of the arrows is a number to identify the ongoing step. After the corresponding number is a short description of the step. The arrows also represent PoE connections between the supply unit 102 and the first port 120 and between the second port 122 and the first port 134. The arrow direction of the broken vertical lines also shows the time direction.

In step 302 the first electrical power requirement (LB) of the first field device 104 is detected by the supply unit 102. In step 304 the power according to the first electrical power requirement is supplied by way of the port 120 for the field device 104. Thus the field device 104 becomes active in step 306. In step 308 the power drawing unit (LEE) is allocated to the first port and in step 310 the power supply unit (LVE) is allocated to the second port 122.

In step 312 the second field device (FG) 206 is detected by the first field device 104 by way of the second port 122. In step 314 the second electrical power requirement (LB) of the second field device is also detected. In step 316 the first message containing information about the overall electrical power requirement is transmitted to the supply unit 102, said overall electrical power requirement being made up of the first power requirement and the second power requirement.

If the supply unit 102 can supply the requested overall power requirement, in step 318 the overall power requirement for the first field device 104 is supplied. In the following step 320 the supply unit 102 transmits the second message to the first field device 104, announcing the provision of the overall power requirement or otherwise rejecting it. In step 322 the first field device 104 optionally makes the second power requirement available to the second field device 106. This allows the field device to be activated, as previously described in FIG. 1.

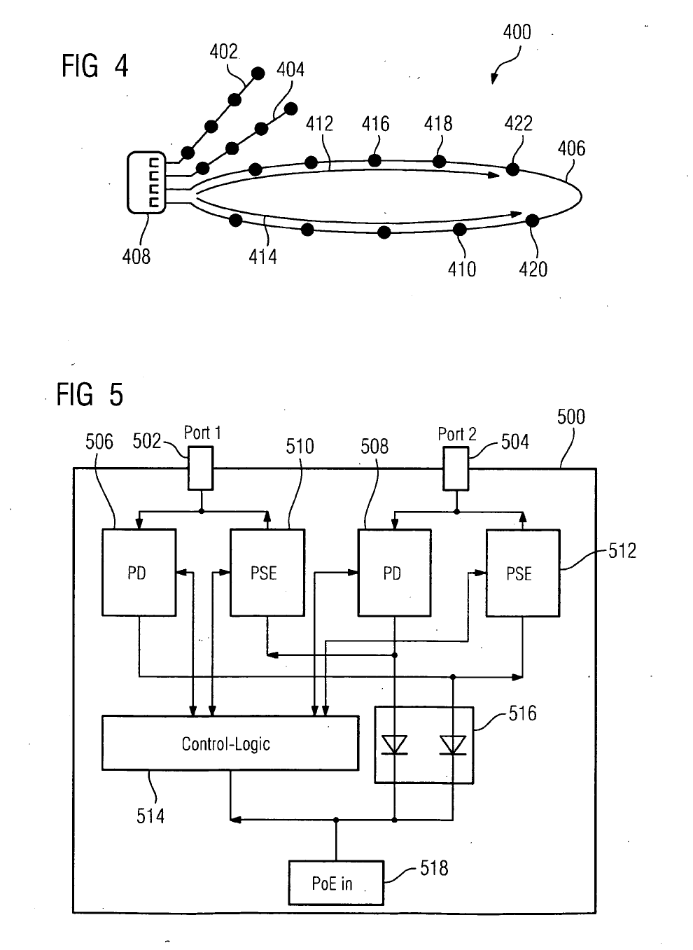

FIG. 4 shows a schematic diagram of the structure of a network 400, having line structures 402, 404 and a ring structure 406. The line structures 402 and 404 and the ring structure 406 here have a power over Ethernet switch 408 as the common node. The power over Ethernet switch 408 here has the functionality of the inventive supply unit.

The individual black-filled circles in the line structures 402 and 404 and in the ring structure 406 here represent field devices 410, which have been started up according to the method described above. The energy required for operation is hereby supplied by the power over Ethernet switch 408 for all field devices, for example for the field device 410, in the line structure 402, in the line structure 404 and in the ring structure 406.

The use of the ring structure 406 has the advantage that it allows a redundant energy supply to be achieved for the inventive field devices. Thus for example the field devices along the path 412 can be activated respectively in the direction of the arrow direction of the path 412. Field device 418 is then supplied by field device 416 and field device 418 supplies field device 422. Similarly the field devices along the path 414 can be activated according to the arrow direction of the path 414. Field device 410 is then the device supplying field device 420.

If field device 410 fails for example or there is a break in the line between field device 410 and field device 420, field device 420 can identify the interruption of the energy supply promptly due to the continuous monitoring of the supplying port described above. With appropriate energy storage in the field device 420 the field device can now change the assignment PSE/PD at its ports and can thus reverse the energy flow direction without interrupting device function. The field device 420 can then take up power by way of the field device 422, with the device 422 then reporting the changed power budget to the device 418, which in turn reports the changed power budget to the device 416, etc.

If the field device 420 does not have an energy storage unit, it is temporarily deactivated and then registers with its PD signature at the field device 422. The field device 422 can then start up the field device 420 according to the method.

FIG. 5 shows a block diagram of a field device 500. The field device 500 here has a first port 502 and a second port 504. The field device 500 also has two power drawing units 506 and 508 and two power supply units 510 and 512. The field device 510 also has a control logic 514 and diodes 516. The control logic 514 acts on all function blocks 506, 508, 510 and 512. Both a power drawing unit and a power supply unit are assigned to each port 502 and 504. The power drawing unit 506 and the power supply unit 510 are assigned to the first port 502. The power drawing unit 508 and the power supply unit 512 are assigned to the second port 504. The power drawing units 506 and 508 and the power supply units 510 and 512 are coupled cross-wise to forward the taken up electrical power by way of the first port 502 or by way of the second port 504. The device's own power supply is combined from both power drawing units 506 and 508 by way of the diodes 616 and by way of the device's own supply 518 (PoE in).

In the powerless state the power drawing units 506 and 508 supply a PD signature corresponding to the standard at the assigned ports 502 and 504.

After activation of the field device 500 by an upstream supply unit, the PD signature at the ports not being supplied is deactivated and the power drawing unit is allocated to the supplied port. The power supply unit is also allocated to the port not being supplied. If for example the field device 500 is supplied by way of the port 502, the power drawing unit 506 is allocated to the port 502; the power supply unit 510 is decoupled from the port 502. The power supply unit 512 is then correspondingly allocated to the port 504 and the power drawing unit 508 is decoupled from the port 504.

The power drawing units 506 and 508 and the power supply units 510 and 512 are coupled cross-wise (the arrow directions characterize the energy flow) to forward the taken up electrical power by way of the first or by way of the second port 502 or 504. The PoE power supply to the device is combined from both power drawing units 506 and 508 by way of the diodes 516 or another suitable coupling and used for the device's own power supply 518 (PoE in). During ongoing operation the power drawing units and the power supply units 506 to 512 can have an extended functionality. If the power budget can be configured, the power class of the power drawing units 506 and 508 for example can be switched by means of the control logic 514.

According to a further embodiment a field device only has one power drawing unit and one power supply unit. The corresponding units are allocated to the corresponding ports after activation of the field device. The field device shown in FIG. 5 therefore has a redundancy, since two units respectively are shown.

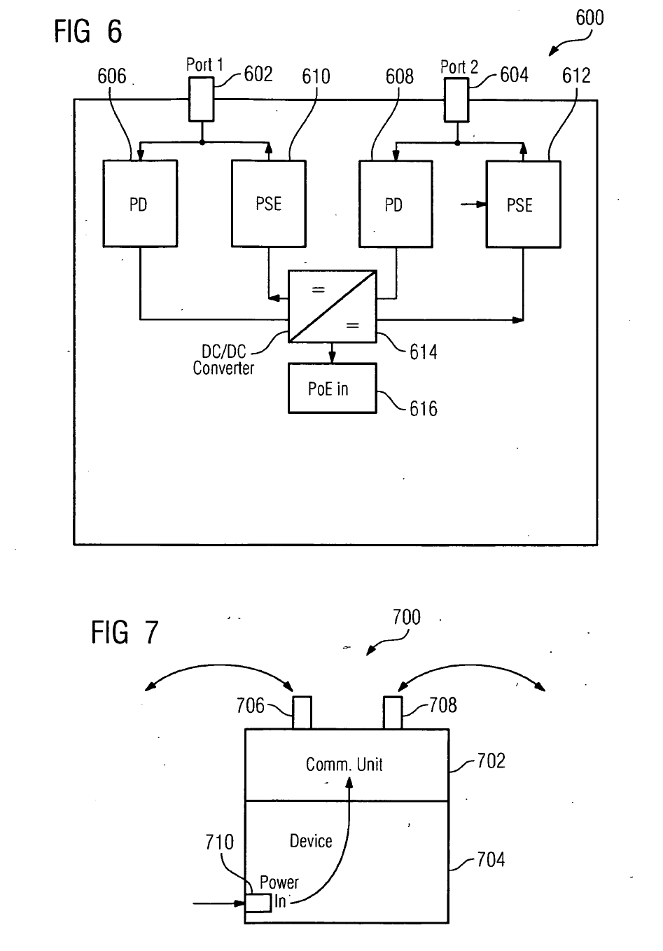

FIG. 6 shows a schematic illustration of a potential isolation between the two ports 602 and 604 of the field device 600 in a block diagram of a field device 600. Like the field device described above in FIG. 5 the field device has two power supply units 610 and 612 and two power drawing units 606 and 608. The device also has DC/DC converters 614 and its own supply (PoE in) 616. The power drawing unit 606 and the power supply unit 610 are hereby assigned to the first port 602. The power drawing unit 608 and the power supply unit 612 are hereby assigned to the second port 604. The power supply specific to the field device 600 comes from the two power drawing units 606 and 608 by way of the DC/DC converters 614 in the supply 616 (PoE in) specifically for the device 600. Use of the DC/DC converters 614 allows the first and second ports 602 and 604 to be galvanically decoupled.

FIG. 7 shows a block diagram of a field device 700 with T-piece functionality. T-piece functionality is frequently required for line and ring topologies in the industrial environment. As far as the current/voltage supply to the lines of PoE devices is concerned, this means that the field device 700 has a communication unit 702 and further device components 704, it being possible for the communication unit 702 to be supplied with electrical energy both by way of the communication port by means of PoE and also by way of an independent device power supply. The other device components 704 are supplied with electrical energy externally by way of a voltage input 710. If the device power supply fails, according to the invention the communication unit can continue to be supplied with electrical energy by means of PoE by way of ports 706 and 708, with the result that the forwarding of data by way of the communication unit is ensured.

According to a further embodiment the field device can have its own power supply that is independent of PoE and supplies not only the communication unit 702 with energy but also allows this energy to be forwarded by way of the power supply units to adjacent field devices. This embodiment allows additional supply points for PoE to be created within a line.

1-27. (canceled)

28. A method for starting up a first field device, comprising:
signaling a first electrical power requirement of the first field device via a first port to a supply unit, the first field device having been previously connected to the supply unit via the first port by a first communication connection;
taking up the power according to the first power requirement by the first field device via the first communication connection and the first port, resulting in the first field device being activated;
allocating a power drawing unit of the first field device to the first port, the power drawing unit provided as a consumer for the taken up power; and
allocating a power supply unit of the first field device to a second port, the power supply unit provided to supply a second power requirement via the second port.

29. The method as claimed in claim 28, further comprising:
detecting a second field device via the second port of the first field device, the second field device having been connected previously to the second port of the first field device via a second communication connection;
determining the second power requirement of the second field device via the second communication connection;
determining the overall power requirement from the first and second power requirements;
transmitting the overall power requirement to the supply unit;
taking up all the required power according to the overall power requirement, provided the supply unit can supply all the required power; and
supplying the second field device with the power according to the second power requirement, provided all the power is received.

30. The method as claimed in claim 29, further comprising:
monitoring the second port supplied by the first field device; and
interrupting the supply to the second field device in the event of a short circuit or excess current in the second communication connection.

31. The method as claimed in claim 30, further comprising:
storing a portion of the electrical energy received;
monitoring the supplying port, with the result that an interruption of the energy supply to the first field device is detectable; and
changing the assignment of the power drawing unit and the power supply unit to the first and second ports, provided an interruption of the energy supply is detected.

32. The method as claimed in claim 31, wherein
a change in the second power requirement of the second field device is detectable by the first field device,
the changed overall power requirement is transmitted to the supply unit and the power according to the changed second power requirement is made available to the second field device, provided the power according to the changed overall power requirement is taken up by the first field device.

33. The method as claimed in claim 32, wherein the overall power requirement or the changed overall power requirement is transmitted to the supply unit via the Simple Network Management Protocol (SNMP).

34. The method as claimed in claim 29, wherein the second field device is detected by the first field device via the Link Layer Discovery Protocol (LLDP).

35. The method as claimed in claim 34, wherein for the field devices having a device-specific signature at the first and second ports in the powerless state, the device-specific signature showing the field devices to be power drawing units, the device-specific signature of the ports not being supplied are deactivated after receipt of the power requirement.

36. The method as claimed in claim 35, wherein the second power requirement of the second field device is determined via the device-specific signature of the second field device.

37. The method as claimed in claim 36, wherein the device-specific signature is a power terminal impedance according to the IEEE 802.3af standard.

38. The method as claimed in claim 37, wherein the communication connections is based on Ethernet technology.

39. The method as claimed in claim 38, wherein the supply unit is a field device upstream of the first field device or a power over Ethernet switch or a power feeder.

40. A field device, comprising:
a first and a second port;
a power supply unit, the power supply unit is allocatable to the first and/or second port, where the power supply unit is provided to supply electrical power via the allocated port;
a power drawing unit, the power drawing unit is allocatable to the first and/or second port, where the power drawing unit is provided as a consumer for power received via the allocated port.

41. The field device as claimed in claim 40, further comprising a signaling device that signals the field devices power requirement to the first and second ports.

42. The field device as claimed in claim 41, wherein the power drawing unit is allocated to the first port after the power requirement has been supplied by a supply unit via the first port and the power supply unit is allocatable to the one second port.

43. The field device as claimed in claim 42, further comprising:
a detecting device that detects a second field device, the second field device having been connected previously to the second port of the field device;
a determining device that determines a second power requirement of the second field device;
an overall power requirement determining device that determines a combined power requirement of the first field device and the second field device;
a transmitting device that transmits the overall power requirement to a supply unit, the field device having been connected previously to the supply unit;
a supply device that supplies the second power requirement for the second field device.

44. The field device as claimed in claim 43, further comprising:
a monitoring device that monitors the second port supplied by the first field device;
a supply interruption device that interrupts the supply to the second field device in the event of a short circuit or excess current in the second communication connection.

45. The field device as claimed in claim 44, further comprising:
an energy storage device that stores a portion of the electrical energy received;
a further monitoring device that monitors the supplying port, wherein an interruption of the energy supply to the first field device is detectable;
an assignment changing device that changes an assignment of the power drawing unit and the power supply unit to the first and/or second port, provided an interruption of the energy supply is detected.

46. The field device as claimed in claim 45, further comprising:
a further detection device that detects a change in the second power requirement of the second field device;
a requesting device that requests a corresponding changed overall power requirement from the upstream supply unit.

47. A computer program product having a computer-executable instructions for a supply unit to start up at least one first field device, the computer program product containing computer-executable instructions for execution on a computer device, comprising:
receiving a first message from the field device via a communication connection, the first message containing information about the power requirement of the field device;
detecting whether the power requirement is suppliable by the supply unit;
transmitting a second message to the field device via the communication connection, the second message containing information about whether the power requirement is suppliable; and
supplying the power requirement for the field device via the communication connection.
